(19) United States
(12) Patent Application Publication
(10) Pub. No.: US 2024/0362727 A1
(43) Pub. Date: Oct. 31, 2024

(54) Method for Operating an Energy Market Platform for an Energy Trade for at Least One Aggregator by Means of an Electronic Computing Device, Computer Program Product and Energy Market Platform

(71) Applicant: BAYERISCHE MOTOREN WERKE AKTIENGESELLSCHAFT, Muenchen (DE)

(72) Inventors: Rainer MEHLHORN, Landsham (DE); Thomas WEBER, Augsburg (DE)

(21) Appl. No.: 18/560,146

(22) PCT Filed: May 11, 2022
(86) PCT No.: PCT/EP2022/062722

§ 371 Date: Nov. 10, 2023

(30) Foreign Application Priority Data
May 12, 2021 (DE) 10 2021 112 418.2

(51) Int. Cl. G06Q 50/06; G06Q 30/0202; G06Q 40/04

(52) U.S. Cl. CPC G06Q 50/06; G06Q 30/0202; G06Q 40/04

(57) ABSTRACT

Systems, methods, and apparatuses are provided for operating an energy market platform for an energy trade for at least one aggregator using an electronic computing device. A time period is specified for the energy trade is subdivided into a multiplicity of time units. A respective energy potential is determined for each of the time units according to at least one energy system. The respective energy potential is represented so as to be visible to the aggregator on the energy market platform. A time-unit-dependent trade energy request is compared with the corresponding energy potential using an input by the aggregator. A multiplicity of at least partially electrically operated motor vehicles is provided. Using the energy market platform, the respective energy is determined such that, at a specific time point, a respective at least partially electrically operated motor vehicle assumes a specific energy volume.

### BACKGROUND AND SUMMARY

The present subject matter relates to a method for operating an energy market platform for an energy trade for at least one aggregator using an electronic computing device. The present subject matter further relates to a computer program product, and to an electronic computing device.

In the context of the digitization of energy market processes, an extension is proposed of the process of communication between the owner of a pool of electrical assets, which term is employed to signify assets which consume or generate electric power, or both, in particular, for example, electric vehicles having a battery, and the energy market-related operator of the pool, also described as an aggregator, wherein the business processes of both parties are appropriately dissociated.

In existing communication interfaces, for example in the energy market operations of storage battery firms, it is assumed that either a battery is available, the energy content of which is available for charging or discharging processes, or that other controllable power generators or power consumers are in place. Accordingly, participation in energy market transactions is only subject to limitations with respect to quantities of power and energy. The energy content of a battery at a specific time point is not stipulated.

DE 10 2017 209 801 A1 relates to a method for operating a multiplicity of technical units in an interconnected system on an electricity distribution network, and provides that, using a central control unit, flexibility data are received from each technical unit, using which the unit indicates a power interval, within which its electric power is permitted to vary, or is expected to vary. From the flexibility data of each unit, in accordance with a predefined optimization target of the interconnected system for each unit, an individual and non-binding incentive function is determined and referred to the respective unit. From each unit, in response to the individual incentive function, a respective operating plan is then received, which describes a time characteristic for the planned exchange of power, in accordance with a local optimization target for the unit, and an overall operating plan for the interconnected system is formed from the unit operating plans.

The object of the present subject matter is the provision of a method, a computer program product and an electronic computing device, by means of which an improved energy trade can be executed.

One aspect of the present subject matter relates to a method for operating an energy market platform for an energy trade for at least one aggregator using an electronic computing device, wherein a time period which is specified for the energy trade is subdivided into a multiplicity of specified time units, and wherein a respective energy potential is determined for each of the time units, according to at least one energy system, and the respective energy potential is represented so as to be visible to the aggregator on the energy market platform, wherein a time-unit-dependent trade energy request is compared with the corresponding energy potential, using an input by the aggregator.

It is intended that, using an energy system, a multiplicity of at least partially electrically operated motor vehicles should be provided and that, using the energy market platform, the respective energy potential thereof is determined such that, at a specific time point, a respective at least partially electrically operated motor vehicle assumes a specific energy volume.

Accordingly, in particular, both from the perspective of the aggregator and from the perspective of motor vehicles, an improved energy trade can be provided.

The term energy volume, in particular, is to be understood as a stipulated energy level in a respective electrical energy store of the respective motor vehicle. For example, the energy volume can be described by a state-of-charge (SOC) of the electrical energy store.

In particular, for example, quantitative power and energy restrictions can be notified to an operator of the pool in a “day-ahead forecast”, and employed by the latter in the form of calls for business. Alternatively, continuous updating can also be executed, for example on a rolling basis for a specified look-ahead period. From a technical standpoint, moreover, the operator is not required to observe any further rules for the conduct of business. For the employment of assets which, in particular, correspond to the at least partially electrically operated motor vehicle, according to the approach envisaged here, the battery is formed by a pool of individual batteries, and additional requirements for power and energy transmission are observed, which relate to the energy content of individual batteries. It can thus be ensured, for example for the owners of electric vehicles, that an energy content at a time point specified by the owner, insofar as possible, is sufficient for their intended journey.

In particular, it is thus considered that, for electrical assets, i.e. for the at least partially electrically operated motor vehicles, it is not only necessary to observe capacity limits, but that charging targets at specific times must also be achieved, particularly at a “departure time”, for example. Using the solution envisaged herein, it is not necessary for the operator of the pool, i.e. the aggregator, to be aware of the exact structure thereof, for example with respect to the number or distribution of individual assets. Instead, the pool is configured for operation as a whole, in order to permit the achievement of a meaningful order of magnitude for the aggregator. This has wide-ranging consequences with regard to data protection or the competitive position of a pool provider. Electric power transmission requirements of the individual owners of the at least partially electrically operated motor vehicles are secured accordingly. In particular, this applies to the effect that the charging target of the at least partially electrically operated motor vehicles is achieved at a specified time point.

To this end, in particular, a separation of options for intervention available to the aggregator is provided. Previous approaches for the marketing of charging processes for at least partially electrically operated vehicles associate the optimization or control of a quantity of the at least partially electrically operated motor vehicles, and the marketing thereof, in a mutually inextricably interwoven process. Accordingly, any separation of the content of business processes between pool operators and the aggregator, for example in order to protect data or sensitive internal structures of the pool operator, is not possible.

It is therefore critical that the results of any forecast of energy flows or power transmission should be prepared in a manner which permits the simple adjustment thereof by an aggregator, without the use of feedback mechanisms, in particular between the forecast and the influence applied by the aggregator. In the light of the relatively small power take-up or power outputs of individual vehicles, only an overall consideration of a moderately large number of assets is of relevance to an aggregator.

To this end, for example, power transmissions of individual at least partially electrically operated vehicles can be aggregated. During energy trading operations, interventions by the aggregator, or “trades”, are reconverted into individual amounts for individual assets, which process is also described as disaggregation. Details of these aggregation and disaggregation stages must not be made public to the aggregator. A control problem, the complexity of which is proportionally scaled to the number of assets, is thus projected onto a control problem having a constant and, in particular, a small number of parameters.

According to an advantageous configuration, the specific energy volume is stipulated by a user of a respective motor vehicle and/or the specific energy volume is stipulated in accordance with a future energy consumption of a respective motor vehicle. Moreover, on the basis of a data analysis of historic journeys, a forecast of the future usage of the motor car can be executed, and a specific energy volume determined accordingly. For example, a user who can be, for example, an owner or keeper of the at least partially electrically operated vehicle, can stipulate the minimum energy volume down to which it is permissible to discharge the energy store of the at least partially electrically operated vehicle. It will then be necessary for the energy market platform to determine the energy potential, such that this minimum quantity of energy in the storage battery is not undershot. It can further be provided that the energy volume is stipulated in accordance with a future energy consumption of the motor vehicle. For example, the user of the motor vehicle can define a distance for the following day which they wish to complete using the motor vehicle. In turn, a minimum energy requirement can thus be determined. This minimum energy requirement can be rated with corresponding buffer margins. According to the stipulated distance of travel, the buffer margin and departure time, it can correspondingly be determined when, and how much energy can permissibly be tapped from or injected into the energy store. The energy potential of the at least partially electrically operated vehicle can thus be determined in a reliable manner. By the summing of individual energy potentials of the individual vehicles, in turn, the overall energy potential can be determined.

It has further proven to be advantageous, in the event of an overshoot of a trade energy request for a respective energy potential, that a visual warning is issued to the operator on the energy market platform. In particular, this is executed in real time, without system feedback, and offline. To this end, for example, on a display apparatus of the operator, for example, a corresponding table can be displayed, in which an entry in red, for example, indicates that the trade energy request, whether for injection into or tapping from the respective power grid, is not consistent with available possibilities on the power grid, such that the operator is alerted accordingly. In particular, no corresponding energy trade on the energy market platform will proceed, until such time as the trade energy request is feasible on the energy market platform.

In a further advantageous configuration, the energy market platform is operated such that, during the stipulated time period, any injection into, or tap-off from the energy system are mutually compensated. In particular, a balancing of the energy system is executed accordingly. In particular, in the present case, the energy system is considered as a multiplicity of at least partially electrically operated vehicles. In particular, the user is also notified, using the display apparatus, whether a corresponding balancing operation is being executed. For example, in the absence of a balancing of the trade energy request, this can also be indicated in red on the display apparatus, for example in the table.

It has further proven to be advantageous if a control of an energy flux to or from the multiplicity of vehicles is executed using the energy market platform. In particular, to this end, different control mechanisms can be delivered by the energy market platform. The aggregator or operator thus has no influence upon the corresponding control mechanisms. It can thus be ensured, using the energy market platform, that the at least partially electrically operated motor vehicles also assume the specific and required energy volume at the stipulated time point. A separation of the aggregator and the energy system applies accordingly.

It is further advantageous if a respective time-dependent energy potential of a respective motor vehicle is determined and, by the summing of the respective time-dependent energy potentials of the motor vehicles, the respective energy potential per unit of time is ascertained for the energy system. In particular, the unit of time can be, for example, 15 minutes. For the respective motor vehicles, according to the desired energy volume, the plug-in time at a charging column and the unplugging time at a charging column, the corresponding energy potential of the motor vehicle is determined accordingly. By the summing of the respective time-dependent energy potentials of the multiplicity of motor vehicles, a respective energy potential is then given per unit of time. In particular, the overall energy potential for the stipulated time period can thus be ascertained.

According to a further advantageous configuration, for the determination of the respective time-dependent energy potential of a respective motor vehicle, a determination of energy flexibility is executed on the basis of a charging strategy for the respective motor vehicle. In particular, the flexibility of individual motor vehicles, and the aggregation of constituent flexibilities in the overall flexibility of a vehicle fleet, can be exploited accordingly. Calculations can be executed continuously or, in particular, at discrete time intervals, for example by the application of a matrix of 15-minute intervals, which is appropriate to the energy industry. In particular, for the calculation of flexibility for a motor vehicle, the limitations of the charging infrastructure are considered, for example the maximum power transmission capacity from the power grid to the motor vehicle battery, or from the motor vehicle battery to the power grid. The limitations of the vehicle battery are also considered, for example the maximum or minimum energy content. Then, on the basis of a forecast of the plug-in time of the motor vehicle to the charging infrastructure, the energy content of the vehicle battery at the plug-in time, the unplugging time of the motor vehicle from the charging infrastructure, the desired energy content of the vehicle battery at the unplugging time, and further influencing parameters for the charging process, including, for example, the pre-conditioning of the vehicle interior and the battery at the unplugging time, an appraisal of potential charging processes is executed. To this end, in particular, two charging sequences are considered, namely “earliest charging” and “latest charging”. Earliest charging is also described as early charging, and latest charging is also described as late charging. In early charging, immediately further to the plug-in process, at any time, the maximum potential power is injected from the power grid into the vehicle battery, until the battery is fully charged or the unplugging time is reached. In late charging, a check is firstly executed as to whether a discharging of the battery is possible, and the vehicle battery is discharged down to a configurable minimum energy content, whereafter the vehicle battery is charged to the requisite target energy content, or until the unplugging time is reached. On the basis of these sequences, in turn, the determination of energy flexibility can be executed. Determination of time-dependent energy potential for the at least one motor vehicle can be improved accordingly.

In a further advantageous configuration, for the determination of the respective time-dependent energy potential, a future employment of the respective motor vehicle is communicated to the energy platform, temporally in advance of the energy trade. In particular, a “day-ahead forecast” can thus be generated. The respective user of the motor vehicle notifies the future employment thereof to the energy market platform, such that the energy market platform can reliably determine the energy potential of the individual motor vehicle, and thus also of the multiplicity of motor vehicles. In particular, different buffer mechanisms can also be incorporated, such that the requirements of the energy platform and of individual users are securely achieved. The aggregator, shortly in advance of the actual energy trade, can then inspect the energy market platform and inspect the corresponding available energy potentials, and can generate a time-unit-dependent trade energy request accordingly.

The method envisaged, in particular, is a computer-implemented method. A further aspect of the present subject matter therefore relates to a computer program product having program code means, which initiate the execution by an electronic computing device, where the program code means are processed by the latter, of a method according to the preceding aspect. A further aspect of the present subject matter therefore relates additionally to a non-transitory computer-readable storage medium having the computer program product.

A further aspect relates to an electronic computing device for operating an energy market platform for an energy trade for at least one aggregator, wherein the electronic computing device is configured to execute a method according to the preceding aspect. In particular, the method is executed using the electronic computing device. To this end, in particular, the electronic computing device comprises processors, electrical components and integrated circuits, in order to permit the execution of a corresponding method. In particular, the electronic computing device is configured as a central electronic computing device, for example as a backend.

Features and combinations of features specified in the preceding description, and features or combinations of features specified hereinafter in the description of the figures and/or in the figures only, are not only applicable in the respective combination indicated, but also in other combinations, or in isolation.

### BRIEF DESCRIPTION OF THE DRAWINGS

FIG. 1 shows a schematic block diagram according to one embodiment of an electronic computing device;

FIG. 2 shows a schematic charging diagram of an at least partially electrically operated motor vehicle, in the form of a time-energy diagram; and

FIG. 3 shows a further schematic diagram of a charging strategy and a trade strategy, in the form of a time-energy diagram.

### DETAILED DESCRIPTION OF THE DRAWINGS

In the figures, functionally equivalent elements are identified by the same reference symbols.

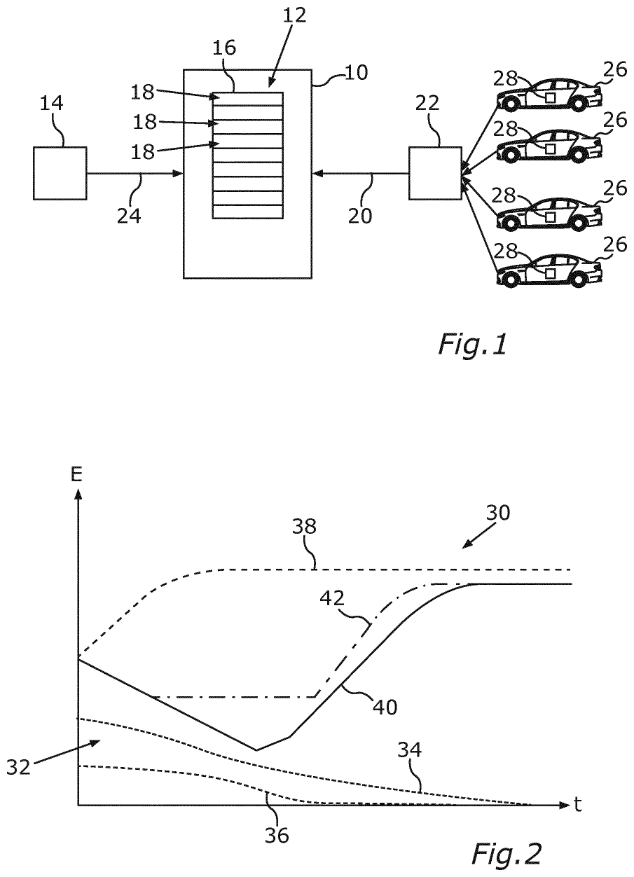

FIG. 1 shows a schematic block circuit diagram of one embodiment of an electronic computing device 10 for operating an energy market platform 12 for an energy trade for at least one aggregator 14.

In the method for operating the market energy platform 12 for the energy trade for the at least one aggregator 14 using the electronic computing device 10, a specified time period 16 for the energy trade is subdivided into a multiplicity of specified time units 18, a respective energy potential 20 is determined for each of the time units 18, according to at least one energy system 22, and the respective energy potential 20 is represented so as to be visible to the aggregator 14 on the energy market platform 12, wherein a time-dependent trade energy request 24 is compared with the corresponding energy potential 20, using an input by the aggregator 14.

It is intended that, using an energy system 22, a multiplicity of at least partially electrically operated motor vehicles 26 are provided and that, using the energy market platform 12, the respective energy potential 20 thereof is determined such that, at a specific time point, a respective at least partially electrically operated motor vehicle 26 assumes a specific energy volume 28.

In particular, it can be provided that the specific energy volume 28 is stipulated by a user or owner of a respective motor vehicle 26 and/or that the specific energy volume 28 is stipulated in accordance with a future energy consumption of a respective motor vehicle 26.

In particular, it can further be provided that, in the event of an overshoot of a trade energy request 24 for a respective energy potential 20, a visual warning is issued to the aggregator 14 on the energy market platform 12. In particular, it can further be provided that a control of an energy flux to or from the multiplicity of motor vehicles 26 is executed using the energy platform 12.

FIG. 2 shows a schematic diagram of a charging strategy for a motor vehicle 26.

In the present case, in particular, it is shown that a respective time-dependent energy potential 30 of a respective motor vehicle 26 is determined and, by the summing of the respective time-dependent energy potentials 30 of the motor vehicles 26, the respective energy potential per unit of time is ascertained for the energy system 22. It can thus be provided, for example, that, for the determination of the respective time-dependent energy potential 30 of a respective motor vehicle 26, a determination of energy flexibility 32 is executed on the basis of a charging strategy for the respective motor vehicle 26. In particular, for the determination of a respective time-dependent energy potential 30, a future employment of the respective motor vehicle 26 is communicated to the energy platform 12, temporally in advance of the energy trade.

In particular, FIG. 2 shows a type of calculation for the above-mentioned flexibility 34, 36 of an individual motor vehicle 26, and the aggregation of flexibilities 34, 36 to give the overall flexibility of a vehicle fleet. In principle, all calculations can be executed continuously or at discrete time intervals, for example by the application of a matrix of 15-minute intervals, which is appropriate to the energy industry. For the calculation of flexibility Fᵢ(t) for a motor vehicle 26, the limitations of the charging infrastructure are considered, for example the maximum power transmission capacity from the power grid to the motor vehicle battery, or from the motor vehicle battery to the power grid. The limitations of the vehicle battery are also considered, for example the maximum or minimum energy content. On the basis of a forecast of the plug-in time of the motor vehicle 26 to the charging infrastructure, the energy content of the vehicle battery at the plug-in time, the unplugging time of the motor vehicle 26 from the charging infrastructure, the desired energy content, i.e. the energy volume 28 of the vehicle battery at the unplugging time, and further influencing parameters for the charging process, including, for example, the pre-conditioning of the interior of the motor vehicle 26 and the battery at the unplugging time, an appraisal of potential charging processes is executed. To this end, in particular, two charging sequences are considered, namely “earliest charging”, which is also described as early charging, and is represented by a curve 38, and “latest charging”, which is also described as late charging, and is represented by a curve 40.

In early charging, immediately further to the plug-in process, at any time, the maximum potential power is injected from the power grid into the vehicle battery, until the battery is fully charged or the unplugging time is reached. In the present case, in particular, the curve 38 shows an example of an energy characteristic E(t) for early charging. In late charging, a check is firstly executed as to whether a discharging of the battery is possible, and the vehicle battery is discharged down to a configurable minimum energy content, whereafter the vehicle battery is charged to the requisite target energy content, or until the unplugging time is reached. This is shown by the lower curve 40, which represents an energy characteristic E(t) for late charging.

At any point t, E(t) in FIG. 2 which lies between the lower and upper curves, i.e. between 38 and 40, a technically feasible charging process can theoretically be executed such that the requisite target energy content of the battery is achieved at the unplugging time. This delivers the leeway required for energy flexibility 32. The model permits the relatively simple integration of further aspects such as, for example, power losses, or other limitations on available power, associated with anticipated additional consumers. In each case, the space between early charging and late charging characteristics for the energy content of the vehicle battery, i.e. between the curves identified by reference numbers 38 and 40, gives the flexibilities 34, 36.

The shorter the time interval between the plug-in time and the unplugging time, the smaller the difference in the energy content characteristics of the vehicle battery between early charging and late charging—in a limiting case, both characteristics coincide.

The size of the area between the energy content characteristics of vehicle batteries, between early charging and late charging, is thus a measure of the flexibility Fᵢ(t) made available by the charging process.

$$F ( t ) = {\int }_{t}^{{t}_{Ab}} {E}_{early} ( τ ) - {E}_{late} ( τ ) d τ$$

Flexibility is thus defined at the plug-in time F(t_{ab})=0, and also externally to an anticipated charging process. An example flexibility characteristic is represented in FIG. 2 by the curves 34 and 36. The determination of flexibility for a motor vehicle 26 can be executed independently of other motor vehicles 26, thus permitting a parallel calculation of flexibilities for the individual motor vehicles 26 in a vehicle fleet. From the result of individual flexibilities Fᵢ(t) for the vehicles in a vehicle fleet, the overall flexibility F(t) of a fleet can also be determined:

$$F ( t ) = {\sum }_{i} {F}_{i} ( t )$$

The method for the calculation of individual flexibilities can alternatively be characterized in that a special charging characteristic E(t) is employed as a basis for a calculation of an upper and lower flexibility F_{charging}(t) and F_{discharging}(t) respectively:

$${F}_{charging} ( t ) = {\int }_{t}^{{t}_{Ab}} {E}_{early} ( τ ) - E ( τ ) d τ \\ {F}_{discharging} ( t ) = {\int }_{t}^{{t}_{Ab}} E ( τ ) - {E}_{early} ( τ ) d τ$$

For example, according to a charging characteristic of this type, early charging can initially proceed until a specific energy level is achieved in the battery, the charging process is then paused, and charging is then finally completed, in an analogous manner to late charging, optionally with an additional time buffer. One example of this is represented by the curve 42. In particular, the curve 42 represents a reference charging process, in which charging or discharging initially proceeds to a specified energy value, and charging is completed thereafter with a time buffer vis-à-vis late charging. In particular, two flexibility curves are generated as a result, which are represented by the two curves 34 and 36. In particular, curve 34 thus represents flexibility of charging, and curve 36 flexibility of discharging.

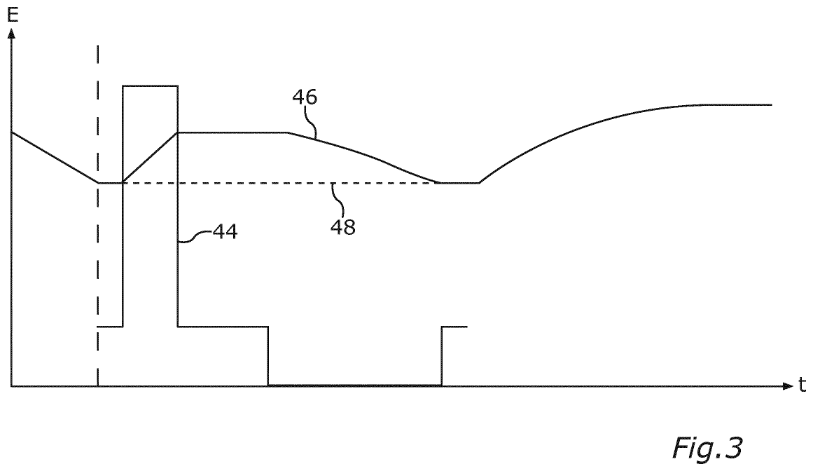

FIG. 3 shows a potential diagram for the embodiment of the energy platform 12 between the aggregator 14 and the energy system 22. In particular, FIG. 3 shows a power adjustment requirement and a resulting energy curve. The curve 44 represents a permissible power adjustment requirement and thus, in particular, a time-dependent trade energy request 24, whereas the curve 46 represents an “energy trajectory” of a vehicle battery during a charging process. The lower curve 48 thus corresponds to the “reference curve”, whereas the upper curve considers the power adjustment requirement.

In particular, it is provided that the energy market platform 12 is operated such that, during the specified time period 16, any injection into the energy system 22 and a tapping of energy from the energy system 22 are mutually balanced. In particular, it is further provided that a control of the energy flux to or from the multiplicity of vehicles 26 is executed using the energy market platform 12.

In particular, it is further provided that, for the determination of the respective time-dependent energy potential 30, a future employment of the respective motor vehicle 26 is communicated to the energy platform 12, temporally in advance of the energy trade.

In particular, it is thus provided that notification of energy flexibility on the preceding day is executed, in particular, at 15-minute intervals, for example. This notification comprises a target working point, which is described as a reference value, and an average power, an upward and downward deviation in the offer of average power for the aggregator, and a permissible upward and downward energy deviation. It should also be observed that the same approach can also be combined with a loss model, which takes account of power losses associated with calls for energy in an approximative manner. In addition to previously determined values, parameters for the loss model will also need to be transmitted.

For the notification of power demand and flexibility for a specified observation period, the “day-ahead forecast”, to the user of a battery, the following steps are required. A determination is executed of all planned charging process of all motor vehicles 26 which coincide with the observation period. The full planned charging process is considered, even outside the scope of the observation period. A calculation of these charging processes is executed. Values for individual charging processes are aggregated in the overall power demand, wherein only those values are employed which fall within the observation period. In particular, this generates a time series of 15-minute intervals and associated demand values, with corresponding flexibility indicators. One of these flexibility indicators is the aggregated power demand, which is given by the formula:

$${P}_{ref} ( t ) = {\sum }_{i} {P}_{ref , i} ( t )$$

for the sum of all reference processes of all motor vehicles 26. This is required as a reference for power procurement. Negative values represent the discharging of batteries, while positive values represent charging.

Moreover, an aggregated maximum power reduction is determined as follows:

$${P}_{min} ( t ) = {\sum }_{i} ( {P}_{min , i} ( t ) - {P}_{ref , i} ( t ) )$$

This represents the potential power reduction on the basis of instantaneous values. Essentially, this parameter is limited by the charging infrastructure, by the achievement of energy limits, by the “degradation” associated with the achievement of upper or lower limits for the energy content of the battery, and by the achievement of charging targets, for example energy volumes at the departure time. Negative values represent the discharging of the battery, while positive values represent charging. The above formula is an example only, and can be further expanded, for example, by the inclusion of safety margins.

Moreover, an aggregated maximum power increase is determined by the following formula:

$${P}_{max} ( t ) = {\sum }_{i} ( {P}_{max , i} ( t ) - {P}_{ref , i} ( t ) )$$

This represents the potential power increase on the basis of instantaneous values. This parameter is essentially limited by the charging infrastructure, or by the achievement of energy limits. In particular, this is determined by a degradation associated with the achievement of an upper or lower limit of the energy content of the battery. Negative values represent the discharging of the battery, while positive values represent charging. The above formula is for example only, and can be further expanded, for example, by the inclusion of safety margins.

Moreover, an aggregated maximum energy reduction for the asset pool is determined. This is determined by the following formula:

$${E}_{min} ( t ) = {\sum }_{i} ( {E}_{late , i} ( t ) - {E}_{ref , i} ( t ) )$$

This represents the potential energy increase associated with a preceding increase in power. This is essentially limited by the achievement of limits for the energy content of the battery. Negative values represent the discharging of the battery, while positive values represent charging. The above formula is an example only, and can be further expanded, for example, by the inclusion of safety margins.

Moreover, an aggregated maximum energy increase for the asset pool can be determined. This is determined by the following formula:

$${E}_{max} ( t ) = {\sum }_{i} ( {E}_{early , i} ( t ) - {E}_{ref , i} ( t ) )$$

This represents the potential energy reduction associated with a preceding reduction of power. This is essentially limited by the achievement of limits for the energy content of the battery, or by stipulated charging targets, e.g. for energy content at the departure time. Negative values represent the discharging of the battery, while positive values represent charging. The above formula is an example only, and can be further expanded, for example, by the inclusion of safety margins.

A requisite power adjustment is further determined. In the event of a call for flexibility, the aggregator transmits their power requirement, with a minimum lead time, for example, equal to a 15-minute interval, on the basis of the preceding notification for the day. Power requirements can be formulated, immediately the notification for the relevant period is available. Conversely to assets which have no state-of-charge, power requirements are required to observe a number of rules. For example, the sum of power demands must be compliant with limits for permissible energy deviations in each 15-minute time interval. Moreover, if power losses are ignored, and no flexibility is offered within a given time period, the total power demand up to this time point must be considered as zero. Moreover, power losses are considered, wherein the sum of power requirements up to this time point must assume a value which corresponds to the anticipated power losses.

An offline calculation of calls for power by the aggregator of the battery aggregator is executed. By the appropriate selection of P_{diff}(t)=ΔP(t) from the values Pₘᵢₙ(t), Pₘₐₓ(t), Eₘᵢₙ(t), Eₘₐₓ(t), the battery operator can determine permissible calls for power, which they can optimize in accordance with their requirements, without the necessity for any knowledge of the exact structure and composition of the constituent individual batteries.

Permissible plans thus consider limits for the energy content of batteries, i.e. the minimum and maximum energy content. Moreover, limits on power transmission via the charging infrastructure are considered. Moreover, the requisite energy content of individual batteries at specific time points, particularly at a departure time, are determined. Compliance with these conditions can naturally be confirmed offline:

$${P}_{min} ( t ) = Δ P ( t ) \leq {P}_{max} ( t ) \\ {E}_{min} ( t ) = Δ E ( t ) \leq {E}_{max} ( t ) \\ {P}_{min} ( t ) = {P}_{max} ( t ) = 0 \text{=>} Δ E ( t ) = 0$$

wherein the energy difference E_{diff}(t)=ΔE(t) is given by a simple progression, in that ΔP(t) represents the 15-minute mean value:

$$Δ E ( t ) = Δ E ( t - Δ t ) + Δ P ( t ) * Δ t$$

The third condition compels the compensation of the energy balance, if no further power adjustment is possible, for example if no motor vehicles 26 are available. In principle, the aggregator 14 can thus calculate permissible calls for energy offline. For example, a table might be formulated, in particular corresponding to an Excel format, for example. Correspondingly, for example, values entered in green can represent a call for energy, the validation of which fulfils the above-mentioned rules. In an analogous manner, for example, the failure of any such validation might be indicated in red.

The calculated flexibility is employed as a characteristic for the disaggregation of control signals which relate to the charging process for the vehicle fleet as a whole into individual vehicles. For example, the individual contribution ΔPᵢ(t) of a motor vehicle 26 to a requisite power adjustment ΔP(t) can be determined by the following formula:

$$Δ {P}_{i} ( t ) = Δ P ( t ) \frac{{F}_{i} ( t )}{F ( t )} , falls F ( t ) > 0$$

This is a simplified representation-optionally, further restrictions might also be considered. Moreover, in particular, a vehicle-specific or system-wide configurable reserve F_{min.i}, below which no individual contribution is delivered, can be considered. It will then be necessary to consider this reserve, in the same way, for the determination of F(t).

Using this approach to the determination of individual contributions which, in particular, is described as disaggregation, mobility requirements are automatically fulfilled, i.e. the target energy content, in particular the energy volume 28 of motor vehicles 26 at the departure time is achieved in an optimum manner. Alternatively, other formulae for the determination of individual contributions, involving the employment of individual flexibilities thus defined, can be applied.

For example, individual contributions can also be determined such that motor vehicles 26 are sorted according to flexibility and, in the sequence thus defined, each motor vehicle 26 delivers its maximum contribution, until such time as the requisite power adjustment is achieved. In particular, this corresponds to a “greedy algorithm”. In the application of this approach, care may additionally be needed to the effect that any constant switchover between two vehicles having virtually the same flexibility is prevented. The above-mentioned externally initiated load adjustments can be achieved, for example, using requests on the part of an aggregator 14, in the event of participation in an energy market, e.g. an intraday market, or using correspondingly effective transactions on the balancing power market. Individual contributions of the motor vehicles 26 can then be calculated in accordance with the requisite power adjustment, with the associated upward or downward flexibility.

Alternatively, a preparatory time period can be introduced, in which a specific sub-quantity of vehicles in a fleet have an energy content which is specified such that the batteries of the sub-quantity of motor vehicles 26 behave in the manner of an individual battery—this is also described as standardization. Disaggregation is thus applied uniformly to the participating motor vehicles 26, in order to prevent any compromise of standardization.

### List of Reference Symbols

10 Electronic computing device

12 Energy market platform

14 Aggregator

16 Specified time period

18 Specified time units

20 Energy potential

22 Energy system

24 Trade energy request

26 Motor vehicles

28 Energy volume

30 Respective energy potential

32 Energy flexibility determination

34 Curve

36 Curve

38 Curve

40 Curve

42 Curve

44 Curve

46 Curve

48 Curve

E Energy

t Time

1. to 10. (canceled)

11. A method for operating an energy market platform for an energy trade for at least one aggregator using an electronic computing device, wherein a time period is specified for the energy trade is subdivided into a multiplicity of time units, the method comprising:
determining a respective energy potential for each of the time units according to at least one energy system, wherein
the respective energy potential is represented so as to be visible to the aggregator on the energy market platform;
comparing a time-unit-dependent trade energy request with the corresponding energy potential using an input by the aggregator;
providing, using an energy system, a multiplicity of at least partially electrically operated motor vehicles; and
determining, using the energy market platform, the respective energy such that, at a specific time point, a respective at least partially electrically operated motor vehicle assumes a specific energy volume.

12. The method according to claim 11, further comprising:
stipulating the specific energy volume by a user of a respective motor vehicle and/or the specific energy volume in accordance with a future energy consumption of a respective motor vehicle.

13. The method according to claim 11, further comprising:
when an overshoot of a trade energy request for a respective energy potential, issuing a visual warning to the aggregator on the energy market platform.

14. The method according to claim 11, wherein
the energy market platform is operated such that, during the stipulated time period, any injection into the energy system, or tap-off from the energy system are mutually compensated.

15. The method according to claim 11, further comprising:
controlling an energy flux to or from the multiplicity of motor vehicles using the energy market platform.

16. The method according to claim 11, further comprising:
determining a respective time-dependent energy potential of a respective motor vehicle; and
summing the respective time-dependent energy potentials of the motor vehicles to determine the respective energy potential per unit of time for the energy system.

17. The method according to claim 16, further comprising:
executing a determination of energy flexibility based on a charging strategy for the respective motor vehicle.

18. The method according to claim 16, further comprising:
communicating a future employment of the respective motor vehicle to the energy market platform, temporally in advance of the energy trade.

19. A non-transitory computer-readable medium comprising instructions operable, when executed by one or more computing systems, to:
perform the method of claim 11.

20. An electronic computing device for operating an energy market platform for an energy trade for at least one aggregator, wherein the electronic computing device is configured to execute the method according to claim 11.
